(19) United States
(12) Patent Application Publication
(10) Pub. No.: US 2026/0026916 A1
(43) Pub. Date: Jan. 29, 2026

(54) DENTAL CROWN

(71) Applicant: Uri Lucian ZILBERMAN, Ness Ziona (IL)

(72) Inventor: Uri Lucian ZILBERMAN, Ness Ziona (IL)

(21) Appl. No.: 18/720,818

(22) PCT Filed: Dec. 13, 2022
(86) PCT No.: PCT/IL2022/051315

§ 371 Date: Jun. 17, 2024

Related U.S. Application Data
(60) Provisional application No. 63/291,791, filed on Dec. 20, 2021.

(51) Int. Cl. A61C 5/73; A61C 5/77

(52) U.S. Cl. CPC A61C 5/73; A61C 5/77

(57) ABSTRACT

A dental crown is disclosed which is configured as an integral structure. The dental crown includes a top portion made of a first material composition being relatively rigid to withstand mechanical forces applied to said top portion during chewing process and a side portion being made of a second material composition and being relatively flexible allowing assembling of the crown on a respective tooth.

### TECHNOLOGICAL FIELD

The present invention is in the field of tooth prostheses and relates to dental crowns.

### BACKGROUND

Dental crowns are commonly used to restore teeth, i.e., regain their original shape, size and health. A dental crown installation is a restorative procedure that is used in modern dentistry to reshape, resize and strengthen a tooth that has been broken or worn down by decay. Generally, the dental crown is a type of cap that is attached to the tooth typically with an adhesive. It serves as the tooth's outer surface, protecting it from further damage and helping patients avoid more serious procedures like extractions or root canals treatment.

The installation process of permanent crowns on a permanent tooth, is generally accomplished in a sequence of stages over a prolonged period of time. First, while the crown is being prepared, it is necessary to keep the shaped tooth or stump protected from shock, further damage and exposure which could ultimately result in loss of the tooth. To this end, a temporary crown is used to be fitted and installed on the shaped tooth immediately. Desirably, the crown form is quickly installed, well fitting, durable, easily removed and replaced and completely protective of the shaped tooth. The temporary crown is placed/installed for a limited period of time, typically from a few days to weeks until the permanent crown is ready. On deciduous teeth the procedure of crowning the molars is a one step procedure. The crown for deciduous molars should give restricted time coverage of the tooth till exfoliation. The deciduous molar is prepared by reducing the occlusal height of the crown and slicing of mesial and distal surfaces, after pulp treatment or due to extensive carious lesion. A prefabricated, precontoured crown is selected from a box with six sizes of crowns for the specific molar and cemented to the tooth. If properly chosen there should be a resistance to seating followed by a snap as the crown fits into place. The retention of the crown on deciduous molars is mechanical by using the bulges of the deciduous molars on the lingual and buccal surfaces.

### GENERAL DESCRIPTION

The technique of the present disclosure aims at providing a novel configuration of a prefabricated dental crown intended for mass-production for deciduous molars and as a temporary crown for permanent teeth. The dental crown of the present disclosure is adapted to be robust to relatively high forces applied thereto during chewing and/or biting, while also being relatively elastic in order to facilitate assembling of the crown on a tooth.

The dental crown of the present disclosure may be prefabricated, namely it is configured such that it can be directly applied to/installed on a tooth simply in a single stage procedure. Accordingly, the dental crown is configured as a self-adjustable structure for wrapping/fitting a respective tooth without a need for any adhesive and/or restorative materials such that possibly only a cement layer may be used for filling a gap between the crown and the tooth.

The dental crown of the present disclosure, while being an integral structure, includes functionally different portions having different material compositions. In particular, a top portion of the crown (a chewing part) is made of a first material composition being relatively rigid/robust to withstand relatively high forces applied thereto during chewing and/or biting, and a side portion of the crown is made of a second material composition which is relatively flexible/elastic so as to facilitate assembling/installing the crown on a respective tooth.

More specifically, the side portion of the crown is elastically deformable, i.e., it can expand and contract/retract upon being mounted on the tooth allowing it to receive the shape of the tooth. This configuration provides that the dental crown can be suitable for restoration of both deciduous teeth and permanent molars. Due to the elastic/flexible properties of the side portion, the original contour of the tooth is preserved after installation of the dental crown of the tooth. The crown configuration obviates a need to adjust its margins to the tooth margins.

The top and side portions may be directly interfacing one another, or may be spaced by an intermediate portion having a gradual change from the first to the second material composition.

The first and second material compositions include/share at least one common material, typically a polymer such as thermoplastic material. In order to provide sufficient rigidity/robustness of the top portion to mechanical forces, the first material composition preferably also includes a so-called “rigid/stiff addition” in the form of nanoparticles (e.g., nano-silica or nano-diamonds).

It should be noted that in order to satisfy requirements for high mechanical strength (tensile strength) of the top portion (exhibit sufficient resilience/robustness), the parameters/properties of the first material composition, i.e., the concentration and/or density of the nanoparticles and possibly also a thickness of the top portion, are selected to provide that the top portion withstands masticatory force (created by the dynamic action of the masticatory muscles during the act of chewing) of up to about 100-300 N for deciduous molars and up to 300-700 N for permanent molars. More specifically, the requirement for desired resilience/robustness to mechanical forces can be achieved by selecting the contents of the nanoparticles in the first material composition and possibly also thickness of the top portion as defined by a stress-strain curve of the material indicating that the yield point occurs when the material reaches a strain of almost 15%.

Generally, the stress-strain curve is a graphical representation of a relationship between stress, derived from measuring the load applied on a sample, and strain, derived from measuring the deformation of the sample, i.e. elongation, compression, or distortion. The resilience property is thus defined by the yield point of the material, which in turn is defined by the transition from elastic behavior (reversible deformation of a material) to plastic behavior of a material (deformation of a material undergoing non-reversible changes of shape in response to applied forces).

The change/variation in the material composition, namely from the first relatively rigid to the second relatively flexible material composition, may be performed gradually, thus forming a “material transition portion” within the interface between the top portion and the side portion, e.g. constituted by the intermediate portion. This transition portion optimizes/enhances coupling between the material composition of the two portions.

A dental crown according to the technique of the present disclosure may be manufactured/fabricated by several methods. Non-limiting examples of such methods include, inter alia, injection molding, compression molding, stamp forming, vacuum forming, thermoforming, transfer molding composite flow molding, machining.

The dental crown of the present disclosure can also be manufactured/fabricated by using any known 3D printing technique. Generally, 3D printing is based on a pre-obtained 3D model of the object to be printed. In order to obtain a 3D model of a crown, the stainless-steel crowns available today can be scanned and used as models. A 3D printer utilizes the 3D model and prints the crown layer-by-layer.

Thus, according to one broad aspect of the technique of the present disclosure, there is provided a dental crown configured as an integral structure, including a top portion and a side portion, the top portion being made of a first material composition which is relatively rigid being adapted to withstand mechanical forces applied to the top portion during chewing process, and the side portion being made of a second material composition which is relatively flexible so as to allow assembling of the crown on a respective tooth.

In some embodiments, the dental crown comprises an intermediate portion forming an interface region between the top and side portions. The intermediate portion is configured as a material transition portion of gradual transition of a material composition from said first material composition to said second material composition, said intermediate portion enhancing physical coupling between the top and side portions of the integral structure of the crown.

For example, the gradual transition of the material composition along the intermediate portion is such that a concentration of the first material composition and the concentration of the second material composition are respectively gradually decreased and increased in a direction from the top portion towards the side portion.

The intermediate portion may be of a thickness gradually decreasing from the top portion towards the side portion.

The second material composition within the intermediate portion may include predetermined particles dispersed therein. For example, the intermediate portion may be characterized by a gradually changing concentration and/or density of said predetermined particles gradually decreasing in a direction from the top portion to the side portion.

The dental crown may be being manufactured by a 3D printing technique.

In some other embodiments, the dental crown is configured such that said side portion extends from a circumference of the top portion.

Preferably, the first and second material compositions include at least one common basic material. At least the first material composition comprises said at least one common basic material and predetermined particles dispersed within said basic material to thereby provide the relative rigidity of the top portion of the crown.

According to some embodiments, the at least one common basic material is a polymer material. For example, the at least one basic material is a plastic material, e.g. a thermoplastic material. The thermoplastic material may include at least one of acetal and Polyether Ether Ketone (PEEK) materials.

Generally, the common basic material can include one of the following: polyacetal, polyacrylate, polymethylmethacrylate (PMMA), polyamide, polyaryletherketone (PAEK), polyetherketone (PEK), polyetheretherketone (PEEK), polyetherimide (PEI), polyethersulfone (PES), polysulfone (PSU), and mixtures of any of these materials.

According to some embodiments, the predetermined particles include at least one of nano-silica particles and nano-diamond particles.

For example, the top portion is made of PEEK or acetal with nano silica or nano diamonds, and the side portion (the flexible margins) is made of PEEK or acetal only. Such structure can be fabricated by injection molding technique or 3D printing.

According to some embodiments, the top and side portions are of different thicknesses.

In some embodiments, the side portion includes an interface region by which it interfaces with the top portion, wherein the interface region has a predetermined width, and the second material composition within the interface region includes a gradually changing concentration and/or density of the predetermined particles gradually decreasing in a direction from the top portion towards the side portion.

According to some embodiments, the side portion has a thickness gradually decreasing from a region of the interface with the top portion towards a bottom of the crown.

The dental crown can be manufactured by injection molding technique, utilizing a multi-part mold defining the top and side portions of the crown.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 a schematic illustrating of a dental crown according to an embodiment of the present invention;

FIG. 2 a schematic illustrating of a dental crown according to another embodiment of the present invention; and

FIG. 3 shows experimental results of Vickers indentation test.

FIG. 4 illustrates a graphic analysis of mass loss value for each of the formulations (rectangular-shaped plates) being tested as a function of number of abrasion cycles (500-2000 cycles);

FIGS. 5 and 6 illustrate the results of analysis of wear index calculated for each of the formulations per number of cycles; and

FIG. 7 shows averaged values of the Vickers pyramid number.

### DETAILED DESCRIPTION OF EMBODIMENTS

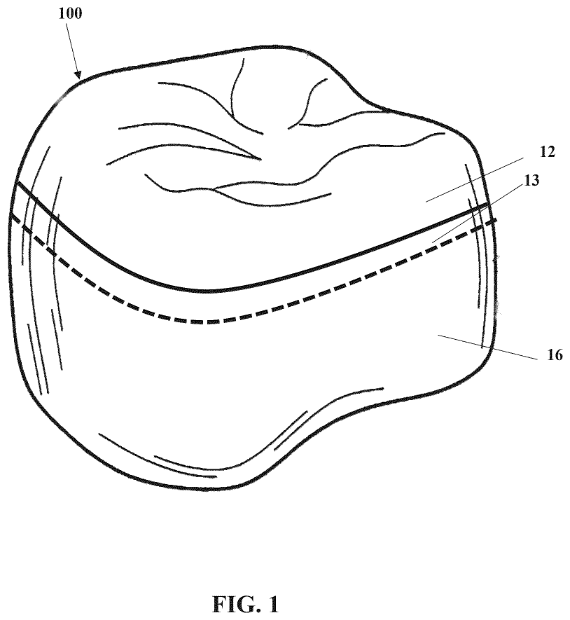

Reference is now made to FIG. 1 schematically illustrating a dental crown 100 according to an embodiment of the present invention.

The dental crown 100 is configured as a continuous integral structure, which includes a top portion 12 and a side portion 16, which may directly extend from the top portion or may be spaced therefrom by an intermediate portion (as will be described further below).

The top portion 12 is made of a first material composition which is relatively rigid to withstand mechanical forces applied to said top 12 portion during chewing process. The side portion 16 (which may directly extend from a circumference of the top portion 12) is made of a second material composition which is relatively flexible to allow assembling of the dental crown 100 on a respective tooth (not shown).

In other words, the side portion 16 can expand for mounting thereof on a tooth and contract/retract upon being mounted on the tooth allowing it to receive the shape of the tooth thus being elastically deformable. This elasticity of the side portion 16 provides that the dental crown 100 can be suitable for use to restore both deciduous and permanent molars.

The first and second material compositions include at least one common basic material. The common basic material provides optimal coupling/fusion between the top portion 12 and the side portion 16 thus creating the integral structure of the crown 100. Such common basic material can be a polymer such as plastic or thermoplastic material. The common basic material can be, inter alia, polyacetal, polyacrylate, polymethylmethacrylate (PMMA), polyamide, polyaryletherketone (PAEK), polyetherketone (PEK), polyetheretherketone (PEEK), polyetherimide (PEI), polyethersulfone (PES), polysulfone (PSU), and mixtures thereof.

Preferably, the thermoplastic polymer is a homo- or co-polymer of acetal resin, polyetheretherketone (PEEK) or polymethylmethacrylate (PMMA).

These materials are generally elastic materials. In order to attain the relatively rigid properties of the top portion 12 the first material composition includes, in addition to the at least one common basic material, predetermined particles and/or nanoparticles (e.g., nano-silica or nano-diamonds). These predetermined particles are mixed with the at least one common basic material such that they are dispersed within said material to thereby provide the relative rigidity of the top portion 12 of the crown 100.

The transition from the first relatively rigid to the second relatively flexible material composition, may be performed gradually/continuously. To this end, the side portion 16 can have an interface region 13 by which the side portion 16 interfaces the top portion 12. In the interface region 13, concentration and/or density of the predetermined particles changes gradually across the interface region 13 such that the concentration and/or density of the particles gradually decreases in a direction from the top portion 12 towards the side portion 16.

The crown may be of the same thicknesses, or preferably of different thicknesses within the top and side portions thereof. According to yet another embodiment, the side portion 16 has a thickness gradually decreasing from a region of interface with the top portion 12 towards a bottom of the crown 100.

The dental crown of the present disclosure can be fabricated by any known suitable injection molding technique. Initially, a mold is prepared based on a predetermined shape of the tooth to be reconstructed. The second material composition is injected in the mold forming the side portion of the crown. After the side portion is molded, the first material composition is injected in the mold to form the top portion of the crown. As mentioned, the first and second material compositions include at least one common basic material. This provides that the top and bottom portions are coupled/fused to one another to form the integral structure of the crown. Alternatively, the first and second material compositions can be injected into the mold concurrently.

The interface region of the crown can be molded in accordance with a selected injection pattern. More specifically, the thermoplastic material and the nanoparticles may be injected concurrently such that the thermoplastic material is injected at constant rate while the nanoparticles are injected in a gradually increasing rate. Consequently, the concentration of the nanoparticles in the interface region increases in a direction from the side portion towards the top portion.

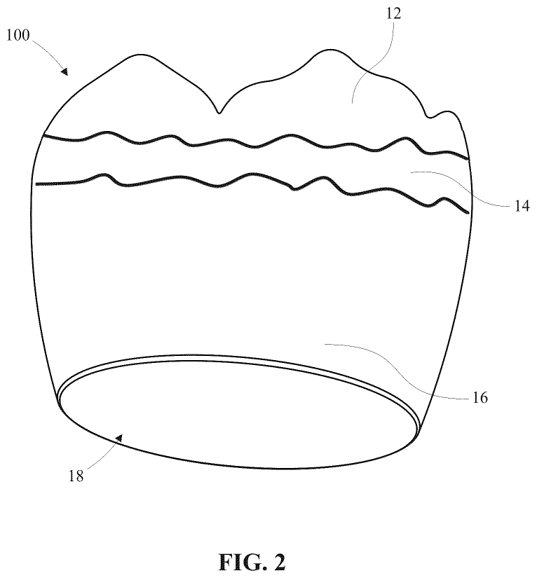

Reference is now made to FIG. 2 schematically illustrating a dental crown 200 according to another embodiment of the present invention.

The dental crown 200 has a top portion 12 made of a first material composition which is relatively rigid to withstand mechanical forces applied to said top portion during chewing process and a side portion 14 made of a second material composition which is relatively flexible so as to allow assembling of the crown 200 on a respective tooth.

The first and second material compositions include at least one common basic material, typically an elastic material such as thermoplastic polymer as described above. The first material composition also includes predetermined particles and/or nanoparticles (e.g., nano-silica or nano-diamonds) for enforcing/hardening of the top portion 12 allowing to be relatively rigid to withstand masticatory/mechanical forces during chewing and/or biting.

As mentioned, the transition from the first relatively rigid to the second relatively flexible material composition, is performed gradually. In this embodiment the material transition is implemented in an intermediate portion 14. The intermediate portion 14 forms an interface region between the top portion 12 and the side portion 16. Thus, the intermediate 14 portion is configured as a material transition portion of gradual transition of a material composition from the first material composition to the second material composition. The intermediate portion enhances physical coupling between the top portion 12 and the side portion 16 of the integral structure of the crown 200.

The gradual transition between the first and second material compositions along the intermediate portion 14 is such that a concentration and/or density of the first material composition and the concentration and/or density of the second material composition are respectively gradually decreased and increased in a direction from the top portion 12 towards the side portion 16.

For example, in the intermediate portion 14, the predetermined particles may gradually vary in their concentration and/or density, which typically decrease in a direction from the top portion 12 to the side portion 16. Alternatively or additionally, the intermediate portion 14 may have a thickness gradually decreasing from the top portion 12 towards the side portion 16.

The dental crown 200 is a prefabricated crown, i.e., readily mountable onto a damaged tooth, by conventional methods. To this end, an inner surface 18 of the crown may be coated by glue, then the crown is disposed to the tooth and surfaces of the side portion 16 are expanded to enable their mount onto the tooth, and then released/retracted to fit the tooth.

As described above, the first and second material compositions of the top and side portions of the crown may be made of, respectively, PEEK with addition of nano-silica particles, and pure PEEK material. PEEK material (polyetheretherketone) is a high-performance semi-crystalline thermoplastic polymer commonly used in engineering applications. PEEK exhibits an outstanding harsh chemical resistance, very low moisture uptake, good fire performance, excellent mechanical strength across a broad temperature range, and good dimensional stability. The inventor has conducted experiments showing the effect of adding nano-silica particles to PEEK material within the top portion on the microhardness properties (Vickers indentation) of the dental crown, i.e. improvement of rigid properties of the occlusal surface of the top portion (12 in FIGS. 1 and 2) of the dental crown for deciduous molars.

The compounds prepared for the experiments were PEEK with addition of different concentrations of the nano-silica particles: zero addition (no nano-silica), 1% nano-silica, 2% nano-silica and 5% nano-silica. The experiments were conducted as follows: for each sample (compound) five indentations were performed by using Phase II Micro Vickers Hardness Tester, model no. 900-391 Force applied was 4.9N and press (force application) time was 5 seconds.

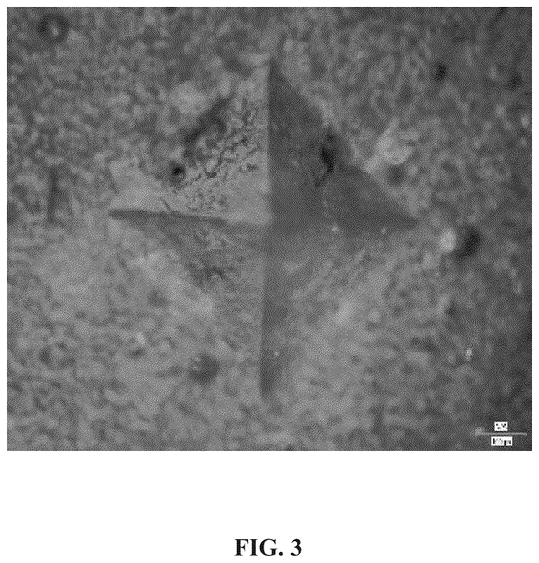

Reference is now made to FIG. 3, showing Vickers indentation result image. The Vickers Hardness (Vickers Pyramid Number HV) results were as follows:
PEEK without nano-silica—53.2 HV;
PEEK with 1% nano-silica—62.3 HV;
PEEK with 2% nano-silica—54.4 HV;
PEEK with 5% nano-silica—55.0 HV.

The addition of 1% nano-silica improved PEEK microhardness by 17%.

The inventor has also conducted a series of tests/experiments with various material formulations forming the top portion (12 in FIGS. 1 and 2) of the dental crown to show that some material formulations exhibit better rigidity to withstand masticatory/mechanical forces and thus better preserve the structural integrity of the dental crown. The experiments were conducted as follows: four (4) different formulations including at least three common materials with different concentrations thereof were fabricated and tested. The four formulation and a Polyoxymethylene (acetal) sample (used as reference) were compressed into a rectangular-shaped plates having a flat surface and a roughened/coarse surface. Then, a mass loss, wear index test and a microhardness test (Vickers indentation) were performed for each of the plates.

Table 1 below exemplifies the materials forming each of the four formulations and corresponding concentration of each material in each of the four formulations, while

Table 2 below shows mechanical and physical characteristics/properties of the four formulations. As can be seen in Table 2, the different formulations have similar mechanical and physical characteristics/properties.

| | PM4706 | PM4706-A | PM4706-B | PM4706-B1 |
|---|---|---|---|---|
| Acetal | 97.80% | 96.80% | 94.80% | 92.80% |
| Silica Natural | 2% | — | 2% | 2% |
| Titan Dioxide | — | 3% | 3% | 5% |
| Heat Stabilizers | 0.20% | 0.20% | 0.20% | 0.20% |

TABLE 2

| Test | Standard | PM4706 | PM4706-A | PM4706-B | PM4706-B1 |
|---|---|---|---|---|---|
| Mechanical Properties | | | | | |
| Tensile Modulus | ISO 527-2/1A | 2860 | 2720 | 3040 | 2950 |
| [MPa] | | | | | |
| Tensile Strength | ISO 527-2/1A | 69 | 69 | 69 | 67 |
| [MPa] | | | | | |
| Strain at Break [%] | ISO 527-2/1A | 25 | 28 | 23 | 17 |
| Flexural Modulus | ISO 178 | 2560 | 2540 | 2630 | 2640 |
| [MPa] | | | | | |
| Flexural Strength | ISO 178 | 94 | 94 | 95 | 95 |
| [MPa] | | | | | |
| Izod impact notched | ISO180 | 9.7 | 11.9 | 11.2 | 9.8 |
| [KJ/m²] | | | | | |
| Physical Properties | | | | | |
| Density | ISO 1183 | 1.42 | 1.44 | 1.45 | 1.45 |
| Molding Shrinkage | — | 2-2.2 | 2.2-2.5 | 2.15-2.6 | 2.2-2.6 |

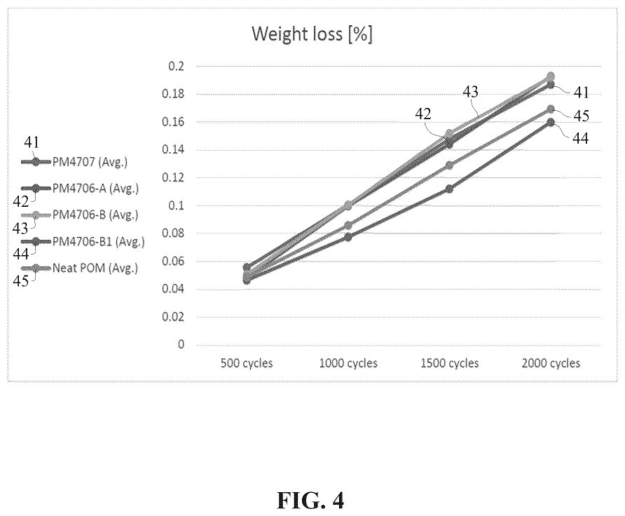

Reference is made to FIG. 4 illustrating a graphic analysis of mass loss value for each of the formulations (rectangular-shaped plates) being tested as a function of number of abrasion cycles (500-2000 cycles). FIG. 4 shows curves 41-45 which correspond to PM4706, PM4706-A, PM4706-B, PM4706-B1, and the neat acetal sample. As can be seen, PM4706-B1 (curve 44) stands out and exhibits minimal mass lost value especially in higher cycle numbers, i.e., 1000-2000 cycles.

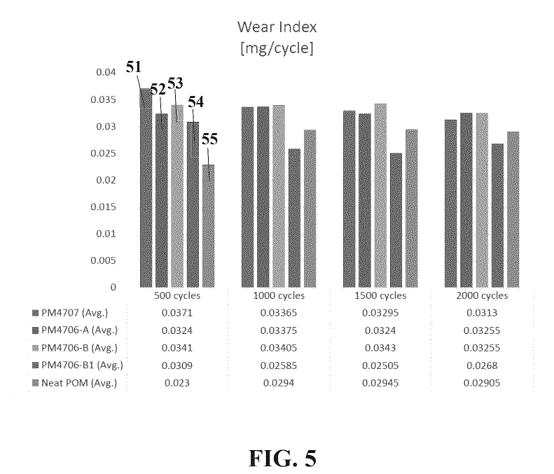

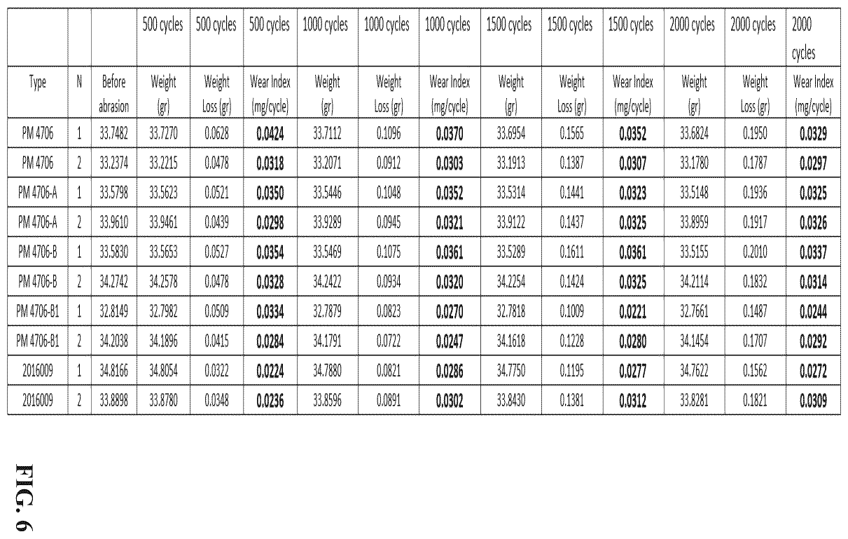

Reference is made to FIG. 5 illustrating a graphic analysis of wear index calculated for each of the formulations per number of cycles. Columns 51-55 represent the wear index for the formulations, PM4706, PM4706-A, PM4706-B, PM4706-B1, and the neat acetal sample, respectively. As can be seen, PM4706-B1 (column 54) stands out and exhibits minimal wear index especially in higher cycle numbers, i.e., 1000-2000 cycles. The wear index (I) for each formulation was calculated as follows:

$$I = \frac{( A - B ) * 1000}{C}$$

wherein A is a weight [mg] of a given rectangular-shaped plate before abrasion, B is a weight [mg] of the given rectangular-shaped plate after abrasion and C is a number of abrasion cycles performed on the given rectangular-shaped plate. It should be noted that FIG. 5 shows averaged values of the wear index (I). The accurate values for the I, A, B and C are shown in Table 3 illustrated in FIG. 6.

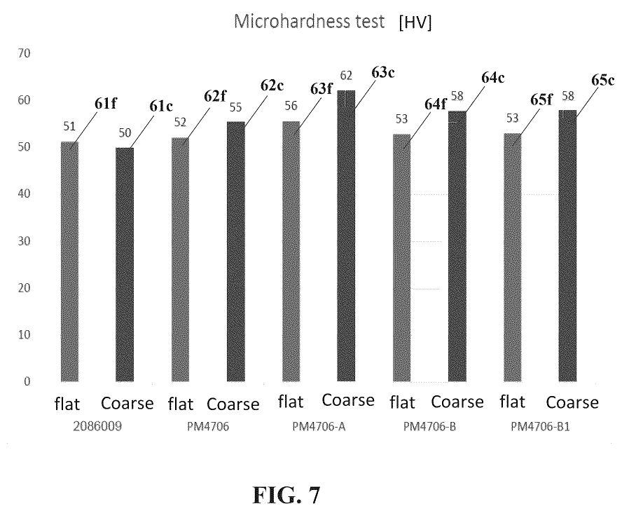

Reference is now made to FIG. 7, illustrating a graphic analysis of a microhardness (Vickers indentation) test performed on both the flat and roughened/coarse surfaces. Columns 61f-65f represent Vickers pyramid number [HV] values for the flat surfaces of the formulations, PM4706, PM4706-A, PM4706-B, PM4706-B1, and the neat acetal sample, respectively, and columns 61s-65fs represent Vickers pyramid number [HV] values for the roughened/coarse surfaces of the formulations of these formulations, respectively. It should be noted that FIG. 7 shows averaged values of the Vickers pyramid number, the accurate values are shown in Table 4 below.

TABLE 4

| PM4706-B1 | | PM4706-B | | PM4706-A | | PM4706 | | 2086009 | |
|---|---|---|---|---|---|---|---|---|---|
| coarse | flat | coarse | flat | coarse | flat | coarse | flat | coarse | flat |
| 46.6 | 52.4 | 60.8 | 52 | 65.5 | 55.3 | 63.3 | 52.4 | 47.64 | 52 |
| 57 | 53.6 | 59.3 | 51.6 | 60.8 | 60.8 | 50.1 | 51.2 | 52 | 51.2 |
| 55.7 | 52.8 | 54.9 | 50.1 | 65.5 | 54 | 53.2 | 52.8 | 47.3 | 53.6 |
| 60.8 | 54 | 54.9 | 52.4 | 62.8 | 54 | 61.3 | 53.6 | 52.4 | 50.5 |
| 58.9 | 53.6 | 58 | 55.3 | 57 | 57.5 | 55.3 | 49.4 | | 49 |
| 67.7 | 51.2 | 58 | 55.3 | 60.8 | 51.6 | 48.7 | 52.8 | | 50.9 |

1. A dental crown configured as an integral structure comprising a top portion and a side portion said integral structure being manufactured by one of the following processes: injection molding, compression molding, stamp forming, vacuum forming, thermoforming, transfer molding composite flow molding, machining; wherein
the top portion is made of a first material composition, and the side portion is made of a second material composition, said first and second material compositions of the top and side portions comprising at least one common basic material of the crown comprising one of the following: polymer material, plastic material, and thermoplastic material; and
at least the first material composition of the top portion contains predetermined particles dispersed in said at least one common basic material of the crown, such that the top portion is relatively rigid as compared to the side portion of the crown to withstand mechanical forces applied to said top portion during chewing process and providing that the side portion is relatively flexible as compared to the top portion allowing assembling of the crown on a respective tooth.

2. The dental crown of claim 1, comprising an intermediate portion forming an interface region between the top and side portions, said intermediate portion being configured as a material transition portion of gradual transition of a material composition from said first material composition to said second material composition, said intermediate portion enhancing physical coupling between the top and side portions of the integral structure of the crown.

3. The dental crown of claim 2, wherein the gradual transition of the material composition along the intermediate portion is such that a concentration of the first material composition and the concentration of the second material composition are respectively gradually decreased and increased in a direction from the top portion towards the side portion.

4. The dental crown of claim 2, wherein the intermediate portion has a thickness gradually decreasing from the top portion towards the side portion.

5. The dental crown of claim 2, wherein the second material composition within the intermediate portion comprises a gradually changing concentration and/or density of predetermined particles gradually decreasing in a direction from the top portion to the side portion.

6. (canceled)

7. The dental crown of claim 1, wherein said side portion extends from a circumference of the top portion.

8.-10. (canceled)

11. The dental crown of claim 1, wherein said at least one basic material comprises the thermoplastic material comprising acetal.

12. (canceled)

13. The dental crown of claim 1, wherein said at least one basic material comprises the at least one thermoplastic material comprising Polyether Ether Ketone (PEEK) material.

14. The dental crown of claim 1, wherein the common basic material comprises one of the following materials: polyacetal, polyacrylate, polymethylmethacrylate (PMMA), polyamide, polyaryletherketone (PAEK), polyetherketone (PEK), polyetheretherketone (PEEK), polyetherimide (PEI), polyethersulfone (PES), polysulfone (PSU), and mixtures thereof.

15. The dental crown of claim 1, wherein said predetermined particles comprise nanodiamond particles.

16. The dental crown of claim 1, wherein said predetermined particles comprise nanosilica particles.

17. The dental crown of claim 1, wherein the first material composition comprises Polyether Ether Ketone (PEEK) material containing nano-silica particles dispersed therein, and the second material composition is composed of PEEK.

18. The dental crown of claim 16, wherein said first material composition comprised PEEK material containing at least 1% of said dispersed nano-silica particles.

19. The dental crown of claim 1, wherein the top and side portions are of different thicknesses.

20. The dental crown of claim 1, wherein the side portion has a thickness gradually decreasing from a region of interface with the top portion towards a bottom of the crown.

21. The dental crown of claim 1, wherein the side portion comprises an interface region by which it interfaces with the top portion, the second material composition within the interface region comprising a gradually changing concentration and/or density of said predetermined particles gradually decreasing in a direction from the top portion.

22. The dental crown of claim 1, being manufactured by injection molding, utilizing a multi-part mold defining said top and side portions of the crown.

23. The dental crown of claim 3, wherein the intermediate portion has a thickness gradually decreasing from the top portion towards the side portion.

24. The dental crown of claim 3, wherein the second material composition within the intermediate portion comprises a gradually changing concentration and/or density of predetermined particles gradually decreasing in a direction from the top portion to the side portion.
